(19) United States
(12) Patent Application Publication
(10) Pub. No.: US 2026/0008500 A1
(43) Pub. Date: Jan. 8, 2026

(54) ANGLE SENSING DEVICE AND METHOD OF CONTROLLING THE SAME

(71) Applicant: HL KLEMOVE CORP., Incheon (KR)

(72) Inventors: Hoo-Chang LEE, Incheon (KR); Kyoung-Chul JO, Incheon (KR)

(21) Appl. No.: 19/089,283

(22) Filed: Mar. 25, 2025

(30) Foreign Application Priority Data
Jul. 4, 2024 (KR) 10-2024-0088350
Nov. 22, 2024 (KR) 10-2024-0168806

(51) Int. Cl. B62D 15/02; B62D 5/04; G01L 5/22

(52) U.S. Cl. CPC B62D 15/0215; B62D 5/0463; G01L 5/221

(57) ABSTRACT

An angle sensing device may include one or more angle sensors, an current sensor, and a controller is configured to determine a rotation angle of the steering wheel on the basis of an output signal from the one or more angle sensors in response to turning-on of the vehicle, determine the determined rotation angle as a final rotation angle of the steering wheel when the determined rotation angle is included in a first reference angle section among a plurality of reference angle sections.

### CROSS-REFERENCE TO RELATED APPLICATIONS

This application claims the priority of Korean Patent Application No. 10-2024-0088350 filed on Jul. 4, 2024, and Korean Patent Application No. 10-2024-0168806 filed on Nov. 22, 2024, in the Korean Intellectual Property Office, the disclosure of which is incorporated herein by reference.

### BACKGROUND

### Field

The disclosed disclosure relates to an angle sensing device for a steering wheel and a method of controlling the same.

### Description of the Related Art

A rotation range of a steering wheel varies depending on purposes of vehicles, weight, and/or manipulation convenience, and an angle sensing device utilizes an angle sensor to determine an absolute angle of a steering wheel.

In the related art, in order to ensure a wide rotation range of the steering wheel with precise performance, a technology has been developed that complementarily applies two angle elements by utilizing a Vernier algorithm and using an angle sensor including two different angle elements.

However, a maximum rotation range, which may be measured by utilizing the technology developed in the related art, is limited. It is impossible to detect a rotation range of the steering wheel that is wider than a maximum rotation range that may be measured by the technology in the related art.

Therefore, there is a need for a technology capable of precisely detecting a rotation range of the steering wheel that is wider than that in the related art.

### SUMMARY

An object to be achieved by the present disclosure is to provide an angle sensing device and a method of controlling the same, the angle sensing device capable of precisely detecting a rotation range of a steering wheel wider than that in the related art.

Another object to be achieved by the present disclosure is to provide an angle sensing device and a method of controlling the same based on a new technology, the angle sensing device capable of detecting a rotation range of a steering wheel larger than a maximum rotation range of the steering wheel that may be determined on the basis of an output value from an angle sensor.

An angle sensing device according to one aspect of the disclosed disclosure may include: one or more angle sensors configured to output an output signal corresponding to a rotation of a steering wheel of a vehicle; a force sensor configured to output information to a force applied to the steering wheel; and a controller connected to the one or more angle sensors and the force sensor, wherein the controller is configured to: determine a rotation angle of the steering wheel based on the output signal from the one or more angle sensors; in response to the determined rotation angle being included in a first reference angle section among a plurality of reference angle sections, determine the determined rotation angle as a final rotation angle of the steering wheel; and in response to the determined rotation angle being included in a second reference angle section continuous from the first reference angle section among the plurality of reference angle sections, determine the final rotation angle based on a change in the force applied to the steering wheel and identified through the information from the force sensor during an operation of a steering motor of the vehicle.

The controller may operate the steering motor so that the steering wheel rotates in at least one of a clockwise direction or a counterclockwise direction.

The second reference angle section may include: a first range to a value increased by a preset value from a maximum value of the first reference angle section; and a second range to a value decreased by the preset value from a minimum value of the first reference angle section.

The controller may determine the determined rotation angle as the final rotation angle in response to the determined rotation angle being included in the first range, and a magnitude of the force applied to the steering wheel being increased when the steering motor performs a first operation so that the steering wheel rotates clockwise.

The controller may determine a value, which is obtained by subtracting a maximum rotation range value of the one or more angle sensors from the determined rotation angle, as the final rotation angle in response to the determined rotation angle being included in the first range, and the magnitude of the force applied to the steering wheel being decreased when the steering motor performs the first operation.

The controller may determine the determined rotation angle as the final rotation angle in response to the determined rotation angle being included in the second range, and a magnitude of the force applied to the steering wheel being decreased when the steering motor performs a second operation so that the steering wheel rotates counterclockwise.

The controller may determine a value, which is obtained by adding up the determined rotation angle and a maximum rotation range value of the one or more angle sensors, as the final rotation angle in response to the determined rotation angle being included in the second range, and the magnitude of the force applied to the steering wheel being increased when the steering motor performs the second operation.

The force sensor may include: at least one of a torque sensor configured to acquire a torque value applied to the steering wheel, or a current sensor configured to acquire a current value supplied to the steering motor.

The controller may operate the steering motor so that the steering wheel sequentially rotates clockwise and then rotates counterclockwise, or the steering wheel sequentially rotates counterclockwise and then rotates clockwise, in response to the determined rotation angle being included in the first range or the second range.

The controller may be configured to: in response to the determined rotation angle being included in the first range, identify a first amount of change between a minimum value and a maximum value of the torque value acquired by the torque sensor in accordance with a clockwise rotation of the steering wheel, or a torque value obtained from the current value acquired by the current sensor in an operation of the steering motor that sequentially rotates the steering wheel; and determine the determined rotation angle as the final rotation angle in response to a value of the first amount of change being increased.

The controller may determine a value, which is obtained by subtracting a maximum rotation range value of the one or more angle sensors from the determined rotation angle, as the final rotation angle, in response to the value of the first amount of change being decreased.

The controller may be configured to: in response to the determined rotation angle being included in the second range, identify a second amount of change between a minimum value and a maximum value of the torque value acquired by the torque sensor in accordance with the clockwise rotation of the steering wheel, or a torque value obtained from the current value acquired by the current sensor in an operation of the steering motor that sequentially rotates the steering wheel; and determine the determined rotation angle as the final rotation angle in response to a value of the second amount of change being decreased.

The controller may determine a value, which is obtained by adding up the determined rotation angle and a maximum rotation range value of the one or more angle sensors, as the final rotation angle, in response to the value of the second amount of change being increased.

An angle sensing device according to one aspect of the disclosed disclosure may include: one or more angle sensors configured to output an output signal corresponding to a rotation of a steering wheel of a vehicle; a force sensor configured to acquire information corresponding to a force applied to the steering wheel; and a controller connected to the one or more angle sensors and the force sensor, in which the controller is configured to: determine a rotation angle of the steering wheel based on the output signal from the one or more angle sensors; in response to the determined rotation angle being equal to or smaller than a first reference angle and equal to or larger than a second reference angle smaller than the first reference angle, determine the determined rotation angle as a final rotation angle of the steering wheel; and in response to the determined rotation angle being larger than the first reference angle or smaller than the second reference angle, determine the final rotation angle based on a change in the force applied to the steering wheel and identified based on the information from the force sensor during an operation of a steering motor of the vehicle.

The controller may determine the determined rotation angle as the final rotation angle in response to the determined rotation angle being larger than the first reference angle, and a magnitude of the force applied to the steering wheel being increased when the steering motor performs a first operation so that the steering wheel rotates clockwise.

The controller may determine a value, which is obtained by subtracting a maximum rotation range value of the one or more angle sensors from the determined rotation angle, as the final rotation angle in response to the determined rotation angle being larger than the first reference angle, and the magnitude of the force applied to the steering wheel being decreased when the steering motor performs the first operation.

The controller may determine the determined rotation angle as the final rotation angle in response to the determined rotation angle being smaller than the first reference angle, and a torque value of the steering motor being decreased when the steering motor performs a second operation so that the steering wheel rotates counterclockwise.

The controller may determine a value, which is obtained by adding up the determined rotation angle and a maximum rotation range value of the one or more angle sensors, as the final rotation angle in response to the determined rotation angle being smaller than the first reference angle, and the torque value of the steering motor being increased when the steering motor performs the second operation.

A method of controlling an angle sensing device according to one aspect of the disclosed disclosure may include: determining a rotation angle of a steering wheel of a vehicle based on an output signal from one or more angle sensors, the output signal corresponding to a rotation of the steering wheel; in response to the determined rotation angle being included in a first reference angle section among a plurality of reference angle sections, determining the determined rotation angle as a final rotation angle of the steering wheel; and in response to the determined rotation angle being included in a second reference angle section continuous from the first reference angle section among the plurality of reference angle sections, determining the final rotation angle based on a change in a force applied to the steering wheel and identified through information output by a force sensor, the information corresponding to the force applied to the steering wheel during an operation of a steering motor of the vehicle.

The operation of the steering motor may include the steering motor causing the steering wheel to rotate in at least one of a clockwise direction or a counterclockwise direction.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view illustrating an angle sensing device according to the embodiment;

FIG. 2 is a block diagram illustrating a control configuration of the angle sensing device according to the embodiment;

FIG. 3 is a graph illustrating a plurality of reference angle sections according to the embodiment;

FIG. 4 is a graph illustrating a force outputted by a steering motor and a rotational displacement of a steering wheel in accordance with perturbation control when a rotation angle of the steering wheel, which is determined in response to an output signal from an angle sensor according to the embodiment, is included in an uncertain rotation range;

FIG. 5 is a flowchart of an operation of the angle sensing device according to the embodiment; and

FIG. 6 is a flowchart of an operation of the angle sensing device according to the embodiment.

### DETAILED DESCRIPTION OF THE EMBODIMENT

Like reference numerals refer to like components throughout the specification. This specification does not describe all the components of the embodiments, and duplicative contents between embodiments or general contents in the technical field of the present disclosure will be omitted. The terms ‘part,’ ‘module,’ ‘member,’ and ‘block’ used in this specification may be embodied as software or hardware, and it is also possible for a plurality of ‘parts,’ ‘modules,’ ‘members,’ and ‘blocks’ to be embodied as one component, or one ‘part,’ ‘module,’ ‘member,’ and ‘block’ to include a plurality of components according to embodiments.

Throughout the specification, when a part is referred to as being ‘connected’ to another part, it includes not only a direct connection but also an indirect connection, and the indirect connection includes connecting through a wireless network.

Also, when it is described that a part ‘includes’ a component, it means that the part may further include other components, not excluding the other components unless specifically stated otherwise.

Throughout the specification, when a member is described as being ‘on’ another member, this includes not only a case in which the member is in contact with the other member but also a case in which another member is present between the two members.

The terms first, second, etc. are used to distinguish one component from another component, and the components are not limited by the above-mentioned terms.

The singular forms ‘a,’ ‘an,’ and ‘the’ include plural referents unless the context clearly dictates otherwise.

In each operation, an identification numeral is used for convenience of explanation, the identification numeral does not describe the order of the operations, and each operation may be performed differently from the order specified unless the context clearly states a particular order.

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

The disclosed disclosure proposes an angle sensing device and a method of controlling the same based on a new technology, the angle sensing device that complements the related art in which an actual rotation angle of a steering wheel cannot be determined in case that the steering wheel rotates by an angle larger than a maximum rotation range of the steering wheel in response to an output signal from an angle sensor.

The actual rotation angle of the steering wheel, which is larger than a rotation angle of the steering wheel that may be determined in response to an output signal from the angle sensor, may be outputted as an uncertain value in an opposite direction because an overflow and/or an underflow.

For example, a rotation angle section (or also referred to as a ‘rotation angle range’), which cannot be determined in response to the output signal from the angle sensor, may be included in an uncertain rotation angle section that may be determined in response to the output signal from the angle sensor. In addition, in case that the rotation angle included in the uncertain rotation angle section is not the actual rotation angle of the steering wheel, an opposite rotation direction value, which is larger than the rotation angle of the steering wheel that may be determined in response to the output signal from the angle sensor, may be outputted.

Therefore, the embodiment of the disclosed disclosure is intended to provide a technology for determining the actual rotation angle of the steering wheel on the basis of a rectilinear restoring force reaction of a device constituting a steering system, e.g., a power piston or a flat spring by applying perturbation clockwise and/or counterclockwise to the steering system when the rotation angle of the steering wheel, which is determined in response to the output signal from the angle sensor, is included in the uncertain rotation angle section.

For example, the rectilinear restoring force reaction of the device constituting the steering system of the embodiment of the disclosed disclosure may be identified on the basis of a change in torque values and/or a difference between current values of a steering motor acquired in response to an output signal from an current sensor as the perturbation is applied to the steering system. Therefore, a technology is provided that determines whether the rotation angle of the steering wheel, which is determined in response to the output signal from the angle sensor, is the actual rotation angle of the steering wheel on the basis of the change in torque values and/or the difference between the current values of the steering motor. In addition, the embodiment of the disclosed disclosure is intended to provide a technology for determining the actual rotation angle by means of computation when the rotation angle of the steering wheel, which is determined in response to the output signal from the angle sensor, is determined as being defined in a direction opposite to that of the actual rotation angle and included in a rotation angle section that exceeds the rotation angle range that may be determined by the angle sensor.

Hereinafter, operation principles and embodiments of the disclosed disclosure will be described in detail with reference to the accompanying drawings.

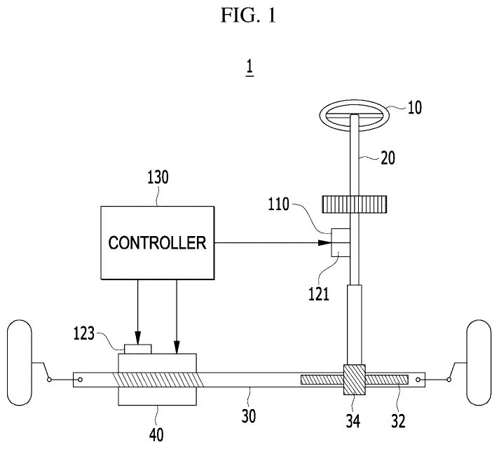

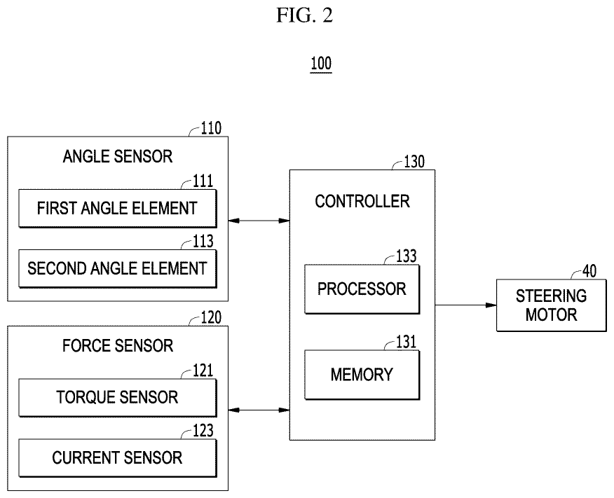

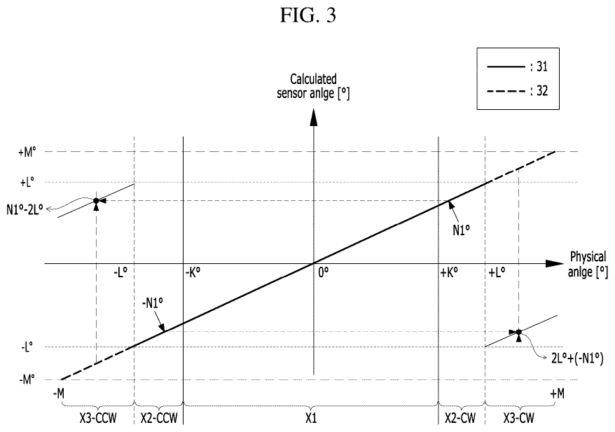

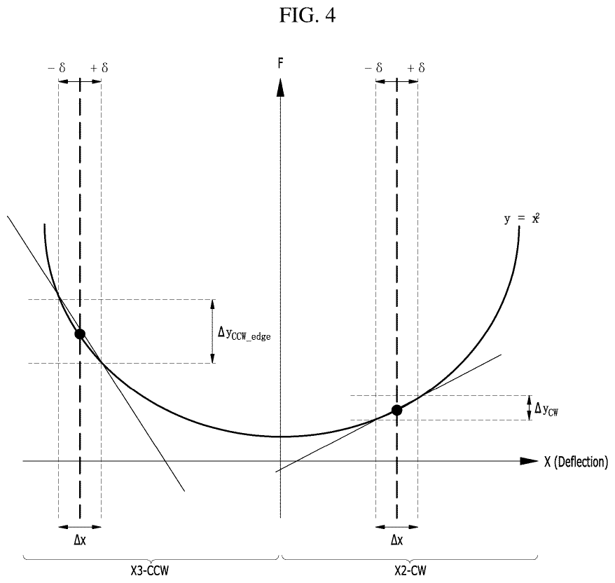

FIG. 1 is a view illustrating a steering system according to the embodiment. FIG. 2 is a block diagram illustrating a control configuration of an angle sensing device included in the steering system according to an embodiment. FIG. 3 is a graph illustrating a plurality of reference angle sections according to the embodiment. FIG. 4 is a graph illustrating a force outputted by a steering motor and a rotational displacement of a steering wheel in accordance with perturbation control when a rotation angle of the steering wheel, which is determined in response to an output signal from an angle sensor according to the embodiment, is included in an uncertain rotation range.

With reference to FIG. 1, a steering system 1 may include a steering wheel 10, a steering column 20, a rack bar assembly 30, a steering motor 40, an angle sensor 110, a torque sensor 121, a current sensor 123, and/or a controller 130. The components illustrated in FIG. 1 are not essential components of the steering system 1, and at least some of the components illustrated in FIG. 1 may be excluded.

With reference to FIG. 2, the torque sensor 121 and/or the current sensor 123 of the steering system 1 may be components of a force sensor 120 configured to output information corresponding to a force applied to the steering wheel 10.

In addition, the steering motor 40, the angle sensor 110, the force sensor 120, and/or the controller 130 of the steering system 1 may be control components of an angle sensing device 100 included in the steering system 1.

The steering wheel 10 may acquire a steering input made by a driver when the driver rotates the steering wheel 10 clockwise or counterclockwise.

The steering column 20 may support the steering wheel 10 and serve as a rotary shaft of the steering wheel 10. The steering column 20 may be rotated by the rotation of the steering wheel 10.

The rack bar assembly 30 may be connected to vehicle wheels and rectilinearly moved by an operation of the steering motor 40. The rack bar assembly 30 may change rotation directions of rotary shafts of the vehicle wheels to change a traveling direction of the vehicle.

For example, the rack bar assembly 30 may rectilinearly move to rotate the rotary shaft of the wheel counterclockwise, such that the vehicle may be steered leftward. In addition, the rack bar assembly 30 may rectilinearly move to rotate the rotary shaft of the wheel clockwise, such that the vehicle may be steered rightward.

For example, the rack bar assembly 30 may include a rack gear 32 and a pinion gear 34. A rectilinear motion of the rack bar assembly 30 may be converted into a rotational motion by the rack gear 32 and the pinion gear 34.

The steering motor 40 may be connected to the rack bar assembly 30 by a power conversion device and provide a rotational force for moving the rack bar assembly 30 rectilinearly. For example, the steering motor 40 may provide a rotational force for moving the rack bar assembly 30 leftward or rightward rectilinearly in response to a control signal from the controller 130. For example, the rotation of the steering motor 40 may be converted into a rectilinear motion by the rack gear 32 and the pinion gear 34.

The angle sensor 110 may be provided as a single angle sensor or a plurality of angle sensors. The angle sensor 110 may detect the rotations of the steering wheel 10 and/or the steering column 20 made by the driver and outputs signals representing rotation angles of the steering wheel 10 and/or the steering column 20. For example, the angle sensor 110 may provide the controller 130 with electrical signals representing the rotation angles of the steering wheel 10 and/or the steering column 20.

With reference to FIG. 2, the angle sensor 110 may include one or more angle elements, e.g., a first angle element 111 and/or a second angle element 113. For example, maximum rotation ranges, which may be measured by the first angle element 111 and the second angle element 113, may be different from each other.

The first angle element 111 may be a Hall-type angle element.

For example, a magnet (not illustrated), which rotates in conjunction with the steering column 20, may be mounted on the steering column 20, and the first angle element 111 may be a Hall integrated circuit (IC). The first angle element 111 may convert a change in magnetic flux density of the magnet into an electrical signal and transmit the electrical signal to the controller 130.

The second angle element 113 may be an inductive angle element.

For example, the second angle element 113 may be a contactless inductive position sensor. The second angle element 113 may convert physical position information, which is made by the rotations of the steering wheel 10 and/or the steering column 20, into an electrical signal and transmit the electrical signal to the controller 130.

The torque sensor 121 may detect the rotation of the steering wheel 10, measure torque applied to the steering wheel 10 by the driver, and output the corresponding signal.

The current sensor 123 may output a signal representing an current value to be supplied to the steering motor 40.

The controller 130 may be electrically connected or communication-connected to the angle sensor 110, the steering motor 40, the torque sensor 121, and/or the current sensor 123.

The controller 130 may receive an output signal from the angle sensor 110.

In response to the output signal received from the angle sensor 110, the controller 130 may determine the rotation angle of the steering wheel 10 and output the rotation angle.

The controller 130 may determine the rotation angle of the steering wheel 10 by means of a Vernier algorithm or a combination of the Vernier algorithm and an angle follower algorithm in response to the output signals from the first and second angle elements 111 and 113. In this case, for example, a maximum rotation range of the steering wheel 10, which may be determined in response to the output signal from the first angle element 111, may be different from a maximum rotation range of the steering wheel 10 that may be determined in response to the output signal from the second angle element 113.

The Vernier algorithm is an algorithm that determines the rotation angle of the steering wheel 10 by combining two signals having different repetitive phases of the angle (or repetitive angles of the signals).

The combination of the Vernier algorithm and the angle follower algorithm is an algorithm that obtains a position of the current steering wheel 10 on the basis of the Vernier algorithm and then determines the rotation angle of the steering wheel 10 on the basis of the angle follower algorithm. The angle follower algorithm may be an algorithm that calculates difference values (Delta angle) by comparing an output value of a previous signal and an output value of the current signal in respect to one of the two signals utilized to determine the rotation angle and then accumulates or adds up the difference value to the existing rotation angle value.

For example, in case that the maximum rotation range, which may be determined in response to the output signal from the first angle element 111, is 296° and the maximum rotation range, which may be determined in response to the output signal from the second angle element 113, is 40°, the controller 130 may determine the maximum rotation range, which may be determined as about 1480°, by applying the Vernier algorithm or the combination of the Vernier algorithm and the angle follower algorithm in response to the output signals from the first and second angle elements 111 and 113.

Because the method of determining the rotation angle of the steering wheel 10 on the basis of the single Vernier algorithm and the combination of the Vernier algorithm and the angle follower algorithm is the technology, a detailed description thereof will be omitted.

The controller 130 may adjust and store a position a center value of the entire rotation angle section (or also referred to as a ‘measurable rotation angle section’ or a ‘maximum rotation range’) of the steering wheel 10 that may be determined by the output range of the angle sensor 110, i.e., the first angle element 111 and the second angle element 113.

For example, the controller 130 may perform offset correction that sets the center value of the entire rotation angle section of the steering wheel 10, which may be determined in response to the output signal from the angle sensor 110, to 0. When the rotation angle section of the steering wheel 10 may be determined as 0° to A (A is an integer) in response to the output signal from the angle sensor 110, the controller 130 may adjust a range of the entire rotation angle section, which may be determined by the angle sensor 110, to −0.5A° to +0.5A°.

For example, in case that the rotation angle section, which may be measured by the steering wheel 10 in response to the output signal from the angle sensor 110, is 0° to +1480°, the controller 130 may adjust and store the range of the measurable rotation angle section to −740° to +740°.

The controller 130 may determine whether to apply the rotation angle of the steering wheel 10, which has been determined in response to the output signal from the angle sensor 110, to the actual rotation angle of the steering wheel 10.

As illustrated in FIG. 3, on the basis of a plurality of predesignated reference angle sections, the controller 130 may determine whether to apply the rotation angle of the steering wheel 10, which has been determined in response to the output signal from the angle sensor 110, to the actual rotation angle of the steering wheel 10.

In FIG. 3, the horizontal axis indicates physical angles corresponding to the actual rotation angles of the steering wheel 10, and the vertical axis indicates calculated angles corresponding to the determined rotation angles of the steering wheel 10 determined in response to the output signal from the angle sensor 110.

In FIG. 3, reference numeral 31 indicates the rotation angles of the steering wheel 10 that may be determined in response to the output signal from the angle sensor 110, and reference numeral 32 indicates the rotation angles that may be the actual rotation angles of the steering wheel 10, i.e., the rotation angles of the steering wheel 10 that cannot be outputted in response to the output signal from the angle sensor 110.

With reference to FIG. 3, the plurality of reference angle sections may include a first reference angle section X1, second reference angle sections X2-CW and X2-CCW, and third reference angle sections X3-CW and X3-CCW.

The first reference angle section X1 and the second reference angle sections X2-CW and X2-CCW may be the rotation angle sections of the steering wheel 10 that may be measured in response to the output signal from the angle sensor 110. The angle sensor 110 may output the signals corresponding to values included in the first reference angle section X1 and the second reference angle sections X2-CW and X2-CCW.

The first reference angle section X1 refers to a section in which an error between the actual rotation angle of the steering wheel 10 and the rotation angle of the steering wheel 10 determined in response to the output signal from the angle sensor 110 is within a predesignated reference error, i.e., a section in which the rotation angle of the steering wheel 10, which has been determined in response to the output signal from the angle sensor 110, to the actual rotation angle of the steering wheel 10.

A center value of the first reference angle section X1 may be 0, and a maximum value and a minimum value may be designated in advance to +K° (K is a real number) and −K°.

The second reference angle sections X2-CW and X2-CCW refer to sections in which an error between the actual rotation angle of the steering wheel 10 and the rotation angle of the steering wheel 10, which has been determined in response to the output signal from the angle sensor 110, is within a predesignated reference error or deviates from the predesignated reference error.

This is because the rotation angle of the steering wheel 10, which has been determined in response to the output signal from the angle sensor 110, is one of the values of the second reference angle sections X2-CW and X2-CCW in case that the steering wheel 10 rotates beyond the rotation angle section of the steering wheel 10 that may be determined in response to the output signal from the angle sensor 110. Therefore, the second reference angle sections X2-CW and X2-CCW refer to sections in which the rotation angle of the steering wheel 10, which has been determined in response to the output signal from the angle sensor 110, needs to be additionally validated.

The second reference angle sections X2-CW and X2-CCW may be designated in advance to include a first range X2-CW having a rotation angle of +K° to +L° in a section continuous from the first reference angle section X1, and a second range X2-CCW having a rotation angle of −K° to −L°. +K° may represent a first reference angle, and −K° may represent a second reference angle.

For example, +K° may be determined on the basis of an actual maximum rotation angle (+M°) of the steering wheel 10 predesignated on the basis of a maximum measured angle (+L°) that may be measured on the basis of a predesignated Vernier algorithm. For example, +K° may be 580° (=740°−(900°−740°)) in case that the maximum measured angle (+L°), which may be measured on the basis of the Vernier algorithm, is 740°, and the actual maximum rotation angle (+M°) of the steering wheel 10 is 900°.

−K° may be determined on the basis of an actual minimum rotation angle (−M°) of the steering wheel 10 predesignated on the basis of a minimum measured angle (−L°) that may be determined on the basis of the predesignated Vernier algorithm. For example, −K° may be −580° (m=−740°−(−900°−(−740°))) in case that the minimum measured angle (−L′), which may be measured on the basis of the Vernier algorithm, is −740°, and the actual minimum rotation angle (−M°) of the steering wheel 10 is −900°.

Among the second reference angle sections X2-CW and X2-CCW, a second-first range X2-CW may be a clockwise side section, and a second-second range X2-CCW may be a counterclockwise side section.

For example, in case that the measurable rotation angle section of the steering wheel 10 is −740° to +740°, +L° of the first range X2-CW, which is the measurable maximum value of the second reference angle sections X2-CW and X2-CCW, is +740°, and −L° of the second range X2-CCW, which is the measurable minimum value of the second reference angle sections X2-CW and X2-CCW, is −740°.

The third reference angle sections X3-CW and X3-CCW are the rotation angle sections of the steering wheel 10 that cannot be determined in response to the output signal from the angle sensor 110. The angle sensor 110 cannot output the signals corresponding to values of the third reference angle sections X3-CW and X3-CCW.

The third reference angle sections X3-CW and X3-CCW may be designated in advance to include a third range X3-CW having a rotation angle of +L° to +M° in a section continuous from the second reference angle sections X2-CW and X2-CCW, and a fourth range X3-CCW having a rotation angle of −L° to −M°.

For example, based on +L°, a distance to K° and a distance to M° may be equal to each other. In addition, based on −L′, a distance to −K° and a distance to −M° may be equal to each other.

Among the third reference angle sections X3-CW and X3-CCW, a third-first range X3-CW may be a clockwise side section, and a third-second range X3-CCW may be a counterclockwise side section.

The controller 130 may receive the output signal from the angle sensor 110 and determine that the rotation angle of the steering wheel 10 determined in response to the output signal from the angle sensor 110 is included in the first reference angle section X1 or the second reference angle sections X2-CW and X2-CCW.

In case that the rotation angle of the steering wheel 10 determined in response to the output signal from the angle sensor 110 is included in the first reference angle section X1, the controller 130 may determine the rotation angle of the steering wheel 10 determined in response to the output signal from the angle sensor 110 as a final rotation angle corresponding to the actual rotation angle of the steering wheel 10. For example, the configuration in which the determined rotation angle of the steering wheel 10 is included in the first reference angle section X1 may mean a configuration in which the determined rotation angle is a minimum value −K° or more and a maximum value +K° or less.

In case that the rotation angle of the steering wheel 10 determined in response to the output signal from the angle sensor 110 is included in the second-first range X2-CW, the actual rotation angle of the steering wheel 10 may be included in the second-first range X2-CW or the third-second range X3-CCW. In addition, in case that the rotation angle of the steering wheel 10 determined in response to the output signal from the angle sensor 110 is included in the second-second range X2-CCW, the actual rotation angle of the steering wheel 10 may be included in the second-second range X2-CCW or the third-first range X3-CW.

Therefore, in case that the rotation angle of the steering wheel 10 determined in response to the output signal from the angle sensor 110 is included in the second reference angle sections X2-CW and X2-CCW, the controller 130 may determine whether the actual rotation angle of the steering wheel 10 is included in the second reference angle sections X2-CW and X2-CCW on the basis of the output signal from the force sensor 120 and the operation of the steering motor 40. That is, the controller 130 may determine whether the rotation angle of the steering wheel 10 determined in response to the output signal from the angle sensor 110 is the actual rotation angle of the steering wheel 10.

The controller 130 may determine whether the rotation angle of the steering wheel 10 determined in response to the output signal from the angle sensor 110 is the actual rotation angle of the steering wheel 10 on the basis of the change in force applied to the steering wheel 10 and identified in response to the output signal from the force sensor 120.

The change in force applied to the steering wheel 10 may include a torque value applied to the steering wheel 10 and acquired in response to the output signal from the torque sensor 121 to be described below, and/or a torque value of the steering motor 40 acquired on the basis of the current value in accordance with the output signal from the current sensor 123. For example, the torque sensor 121 may be the torque sensor 121 integrated with the angle sensor 110.

According to the embodiment, the controller 130 may acquire the torque value applied to the steering wheel 10 in response to the output signal from the torque sensor 121 in case that the rotation angle of the steering wheel 10 determined in response to the output signal from the angle sensor 110 is included in the second reference angle sections X2-CW and X2-CCW and the driver manipulates the steering wheel 10 so that the steering wheel 10 rotates in a first direction and/or a second direction. For example, the first direction may be predesignated as a clockwise direction (or a plus direction), and the second direction may be predesignated as a counterclockwise direction (or a minus direction).

The controller 130 may determine whether the rotation angle of the steering wheel 10 determined in response to the output signal from the angle sensor 110 is the actual rotation angle of the steering wheel 10 on the basis of the acquired torque value.

In another embodiment, in case that the rotation angle of the steering wheel 10 determined in response to the output signal from the angle sensor 110 is included in the second reference angle sections X2-CW and X2-CCW, the controller 130 may operate the steering motor 40 so that the steering wheel 10 rotates in the first direction and/or the second direction. In addition, the controller 130 may acquire the current value of the steering motor 40 in response to the output signal from the current sensor 210 during the operation of the steering motor 40 so that the steering wheel 10 rotates in the first direction and/or the second direction. The controller 130 may acquire the torque value of the steering motor 40 on the basis of the acquired current value. Because the configuration in which the torque value is calculated on the basis of the current value of the steering motor 40 is a technology in the related art, a detailed description thereof will be omitted.

According to the embodiment, the controller 130 may identify a reference angle section included in the actual rotation angle of the steering wheel 10 on the basis of a rate of change in angle detected by the angle sensor 110 in case that the rotation angle of the steering wheel 10 determined in response to the output signal from the angle sensor 110 is included in the second reference angle sections X2-CW and X2-CCW and the driver manipulates the steering wheel 10 so that the steering wheel 10 rotates in the first direction and/or the second direction.

The controller 130 may determine whether the rotation angle of the steering wheel 10 determined in response to the output signal from the angle sensor 110 is the actual rotation angle of the steering wheel 10 on the basis of the current value and/or the torque value of the steering motor 40.

When the driver manipulates the steering wheel 10 or the controller 130 performs the perturbation control, i.e., controls the operation of the steering motor 40 so that the steering wheel 10 rotates in the first direction, i.e., the clockwise direction when the actual rotation angle of the steering wheel 10 is positioned in the second-first range X2-CW, i.e., the clockwise side section, torque may be applied to the steering motor 40 in a direction in which a force F outputted by the steering motor 40 in accordance with a reaction force of the steering wheel 10 increases.

When the driver manipulates the steering wheel 10 or the controller 130 performs the perturbation control, so that the steering wheel 10 rotates in the second direction, i.e., the counterclockwise direction when the actual rotation angle of the steering wheel 10 is positioned in the second-first range X2-CW, torque may be applied to the steering motor 40 in a direction in which the force F outputted by the steering motor 40 decreases.

When the driver manipulates the steering wheel 10 or the controller 130 performs the perturbation control so that the steering wheel 10 rotates in the second direction, i.e., the counterclockwise direction when the actual rotation angle of the steering wheel 10 is positioned in the second-second range X2-CCW, i.e., the counterclockwise side section, torque may be applied to the steering motor 40 in the direction in which the force F outputted by the steering motor 40 in accordance with the reaction force of the steering wheel 10 increases.

When the driver manipulates the steering wheel 10 or the controller 130 performs the perturbation control, so that the steering wheel 10 rotates in the first direction, i.e., the clockwise direction when the actual rotation angle of the steering wheel 10 is positioned in the second-second range X2-CCW, torque may be applied to the steering motor 40 in a direction in which the force F outputted by the steering motor 40 decreases.

With reference to FIG. 4, in order to identify the actual rotation angle of the steering wheel 10, the controller 130 may perform control for the manipulation of the driver or the operation of the steering motor 40 so that the steering wheel 10 rotates in the first direction +δ, which is a direction corresponding to the direction of the second-first range X2-CW, and then rotates in the second direction-d.

In this case, for example, in case that the actual rotation angle of the steering wheel 10 is positioned in the second-first range X2-CW, the force F applied to the steering wheel 10 (and/or also referred to as the force F outputted by the steering motor 40) may increase, and then the force F applied to the steering wheel 10 (and/or also referred to as the force F outputted by the steering motor 40) may decrease.

As illustrated in FIG. 4, it can be seen that when a relationship between the amount of change in the force F and the overall rotational displacement of the steering wheel 10 in accordance with the rotation of the steering wheel 10 in the first direction +δ and the second direction −δ is shown in the graph, the relationship may be identical to a relationship between x and Δycw in FIG. 4 in a non-linear form, and a gradient in the graph may be increased.

Therefore, the controller 130 may identify that the value of the amount of change between the minimum value and the maximum value of the torque value of the steering wheel 10 with respect to the displacement of the rotation angle of the steering wheel 10 in the clockwise direction is increased. In addition, the controller 130 may identify that the value of the amount of change between the minimum value and the maximum value of the torque value of the steering motor 40 with respect to the displacement of the rotation angle of the steering wheel 10 in the clockwise direction is increased.

In contrast, for example, in case that the actual rotation angle of the steering wheel 10 is positioned in the third-second range X3-CCW, the force F may be decreased, and then the force F may be increased.

As illustrated in FIG. 4, it can be seen that when the relationship between the amount of change in the force F and the overall rotational displacement of the steering wheel 10 in accordance with the rotation of the steering wheel 10 in the first direction +δ and the second direction −δ is shown in the graph, the relationship may be identical to a relationship between x and Δyccw_edge in FIG. 4 in a non-linear form, and a gradient may be decreased.

Therefore, the controller 130 may identify that the value of the amount of change between the minimum value and the maximum value of the torque value of the steering wheel 10 with respect to the displacement of the rotation angle of the steering wheel 10 in the clockwise direction is decreased. In addition, the controller 130 may identify that the value of the amount of change between the minimum value and the maximum value of the torque value of the steering motor 40 with respect to the displacement of the rotation angle of the steering wheel 10 in the clockwise direction is decreased.

Additionally, it can be seen that ycw, which is a magnitude of the amount of change of the force F when the position of the actual rotation angle of the steering wheel 10 is in the second-first range X2-CW, is different from Δyccw_edge, which is a magnitude of the amount of change of the force F when the position of the actual rotation angle of the steering wheel 10 is in the third-second range X3-CCW, and Δyccw_edge has a much larger value than Δycw.

According to the embodiment, based on the above-mentioned principle, the steering wheel 10 may rotate in the first direction and then rotate in the second direction (or rotate in the first direction and then rotate in the first direction) on the basis of the control of the controller 130 for the manipulation of the steering wheel 10 by the driver and/or the operation of the steering motor 40. In this case, the controller 130 may determine whether the rotation angle of the steering wheel 10, which is determined in response to the output signal from the angle sensor 110 by monitoring the change in force applied to the steering wheel 10 in response to the output signal from the force sensor 120, corresponds to the actual rotation angle of the steering wheel 10.

For example, the controller 130 may determine the torque value of the steering wheel 10 in response to the output signal from the torque sensor 121 in case that the rotation angle of the steering wheel 10 determined in response to the output signal from the angle sensor 110 is included in the second-second range X2-CCW and the driver manipulates the steering wheel 10 so that the steering wheel 10 rotates in the first direction and then rotates in the second direction.

The controller 130 may determine that the actual rotation angle of the steering wheel 10 is included in the second-second range X2-CCW in case that the controller 130 identifies that the value of the amount of change between the minimum value and the maximum value of the torque value of the steering wheel 10 with respect to the displacement of the rotation angle of the steering wheel 10 in the clockwise direction is decreased while the steering wheel 10 rotates in the first direction and then rotates in the second direction. That is, the rotation angle of the steering wheel 10 determined in response to the output signal from the angle sensor 110 may be determined as the final rotation angle corresponding to the actual rotation angle of the steering wheel 10.

The controller 130 may determine that the actual rotation angle of the steering wheel 10 is included in the third-first range X3-CW instead of the second-second range X2-CCW in case that the controller 130 identifies that the value of the amount of change between the minimum value and the maximum value of the torque value of the steering wheel 10 in the clockwise direction is increased while the steering wheel 10 rotates in the first direction and then rotates in the second direction. The detailed embodiment in which the final rotation angle corresponding to the actual rotation angle of the steering wheel 10 is determined when the actual rotation angle of the steering wheel 10 is determined as being included in the third-first range X3-CW instead of the second-second range X2-CCW will be described below.

Meanwhile, the controller 130 may determine the torque value of the steering wheel 10 in response to the output signal from the torque sensor 121 in case that the rotation angle of the steering wheel 10 determined in response to the output signal from the angle sensor 110 is included in the second-first range X2-CW and the driver manipulates the steering wheel 10 so that the steering wheel 10 rotates in the first direction and then rotates in the second direction (or rotates in the first direction and then rotates in the first direction).

The controller 130 may determine that the actual rotation angle of the steering wheel 10 is included in the second-first range X2-CW in case that the controller 130 identifies that the value of the amount of change between the minimum value and the maximum value of the torque value of the steering wheel 10 with respect to the displacement of the rotation angle of the steering wheel 10 in the clockwise direction is increased while the steering wheel 10 rotates in the first direction and then rotates in the second direction. That is, the rotation angle of the steering wheel 10 determined in response to the output signal from the angle sensor 110 may be determined as the final rotation angle corresponding to the actual rotation angle of the steering wheel 10.

The controller 130 may determine that the actual rotation angle of the steering wheel 10 is included in the third-second range X3-CCW instead of the second-first range X2-CW in case that the controller 130 identifies that the value of the amount of change between the minimum value and the maximum value of the torque value of the steering wheel 10 with respect to the displacement of the rotation angle of the steering wheel 10 in the clockwise direction is decreased while the steering wheel 10 rotates in the first direction and then rotates in the second direction. The detailed embodiment in which the final rotation angle corresponding to the actual rotation angle of the steering wheel 10 is determined when the actual rotation angle of the steering wheel 10 is determined as being included in the third-second range X3-CCW instead of the second-first range X2-CW will be described below.

As another example, the controller 130 may operate the steering motor 40 so that the steering wheel 10 rotates in the first direction and then rotates in the second direction in case that the rotation angle of the steering wheel 10 determined in response to the output signal from the angle sensor 110 is included in the second-second range X2-CCW. In addition, the controller 130 may determine the torque value of the steering motor 40 in response to the output signal from the current sensor 123 during the operation of the steering motor 40.

The controller 130 may determine that the actual rotation angle of the steering wheel 10 is included in the second-second range X2-CCW in case that the controller 130 identifies that the value of the amount of change between the minimum value and the maximum value of the torque value of the steering motor 40 with respect to the displacement of the rotation angle of the steering wheel 10 in the clockwise direction is decreased while the steering wheel 10 rotates in the first direction and then rotates in the second direction. That is, the rotation angle of the steering wheel 10 determined in response to the output signal from the angle sensor 110 may be determined as the final rotation angle corresponding to the actual rotation angle of the steering wheel 10.

The controller 130 may determine that the actual rotation angle of the steering wheel 10 is included in the third-first range X3-CW instead of the second-second range X2-CCW in case that the controller 130 identifies that the value of the amount of change between the minimum value and the maximum value of the torque value of the steering motor 40 with respect to the displacement of the rotation angle of the steering wheel 10 in the clockwise direction is increased while the steering wheel 10 rotates in the first direction and then rotates in the second direction. The detailed embodiment in which the final rotation angle corresponding to the actual rotation angle of the steering wheel 10 is determined when the actual rotation angle of the steering wheel 10 is determined as being included in the third-first range X3-CW instead of the second-second range X2-CCW will be described below.

Meanwhile, the controller 130 may operate the steering motor 40 so that the steering wheel 10 rotates in the first direction and then rotates in the second direction in case that the rotation angle of the steering wheel 10 determined in response to the output signal from the angle sensor 110 is included in the second-first range X2-CW. In addition, the controller 130 may determine the torque value of the steering motor 40 in response to the output signal from the current sensor 123 during the operation of the steering motor 40.

The controller 130 may determine that the actual rotation angle of the steering wheel 10 is included in the second-first range X2-CW in case that the controller 130 identifies that the value of the amount of change between the minimum value and the maximum value of the torque value of the steering motor 40 with respect to the displacement of the rotation angle of the steering wheel 10 in the clockwise direction is increased while the steering motor 40 operates so that the steering wheel 10 rotates in the first direction and then rotates in the second direction. That is, the rotation angle of the steering wheel 10 determined in response to the output signal from the angle sensor 110 may be determined as the final rotation angle corresponding to the actual rotation angle of the steering wheel 10.

The controller 130 may determine that the actual rotation angle of the steering wheel 10 is included in the third-second range X3-CCW instead of the second-first range X2-CW in case that the controller 130 identifies that the value of the amount of change between the minimum value and the maximum value of the torque value of the steering motor 40 with respect to the displacement of the rotation angle of the steering wheel 10 in the clockwise direction is decreased while the steering wheel 10 rotates in the first direction and then rotates in the second direction. The detailed embodiment in which the final rotation angle corresponding to the actual rotation angle of the steering wheel 10 is determined when the actual rotation angle of the steering wheel 10 is determined as being included in the third-second range X3-CCW instead of the second-first range X2-CW will be described below.

According to another embodiment based on the above-mentioned principle, the controller 130 may operate the steering motor 40 so that the steering wheel 10 rotates in the second direction in case that the rotation angle of the steering wheel 10 determined in response to the output signal from the angle sensor 110 is included in the second-second range X2-CCW. In this case, the controller 130 may monitor the torque value of the motor 40 and determine whether the rotation angle of the steering wheel 10 determined in response to the output signal from the angle sensor 110 corresponds to the actual rotation angle of the steering wheel 10.

The controller 130 may operate the steering motor 40 so that the steering wheel 10 rotates in the second direction in case that the rotation angle of the steering wheel 10 determined in response to the output signal from the angle sensor 110 is included in the second-second range X2-CCW. The controller 130 may determine the torque value of the steering motor 40 in response to the output signal from the current sensor 123 during the operation of the steering motor 40.

In case that the torque value of the steering motor 40 is increased during the operation of the steering motor 40, the controller 130 may determine that the actual rotation angle of the steering wheel 10 is included in the second-second range X2-CCW, i.e., determine the rotation angle of the steering wheel 10 determined in response to the output signal from the angle sensor 110 as the final rotation angle corresponding to the actual rotation angle of the steering wheel 10.

The controller 130 may determine that the actual rotation angle of the steering wheel 10 is included in the third-first range X3-CW instead of the second-second range X2-CCW in case that the torque value of the steering motor 40 is decreased during the operation of the steering motor 40. The detailed embodiment in which the final rotation angle corresponding to the actual rotation angle of the steering wheel 10 is determined when the actual rotation angle of the steering wheel 10 is determined as being included in the third-first range X3-CW instead of the second-second range X2-CCW will be described below.

The controller 130 may operate the steering motor 40 so that the steering wheel 10 rotates in the first direction in case that the rotation angle of the steering wheel 10 determined in response to the output signal from the angle sensor 110 is included in the second-first range X2-CW. In this case, the controller 130 may monitor the torque value of the motor 40 and determine whether the rotation angle of the steering wheel 10 determined in response to the output signal from the angle sensor 110 corresponds to the actual rotation angle of the steering wheel 10.

The controller 130 may operate the steering motor 40 so that the steering wheel 10 rotates in the first direction in case that the rotation angle of the steering wheel 10 determined in response to the output signal from the angle sensor 110 is included in the second-first range X2-CW. The controller 130 may determine the torque value of the steering motor 40 in response to the output signal from the current sensor 123 during the operation of the steering motor 40.

In case that the torque value of the steering motor 40 is increased during the operation of the steering motor 40, the controller 130 may determine that the actual rotation angle of the steering wheel 10 is included in the second-first range X2-CW, i.e., determine the rotation angle of the steering wheel 10 determined in response to the output signal from the angle sensor 110 as the final rotation angle corresponding to the actual rotation angle of the steering wheel 10.

The controller 130 may determine that the actual rotation angle of the steering wheel 10 is included in the third-second range X3-CCW instead of the second-first range X2-CW in case that the torque value of the steering motor 40 is decreased during the operation of the steering motor 40. The detailed embodiment in which the final rotation angle corresponding to the actual rotation angle of the steering wheel 10 is determined when the actual rotation angle of the steering wheel 10 is determined as being included in the third-second range X3-CCW instead of the second-first range X2-CW will be described below.

According to the above-mentioned embodiments, the controller 130 may determine the actual rotation angle of the steering wheel 10 on the basis of the rotation angle of the steering wheel 10 determined in response to the output signal from the angle sensor 110 in case that the controller 130 determines that the actual rotation angle of the steering wheel 10 is included in the third reference angle sections x3-1 and x3-2 instead of the second reference angle sections x2-1 and x2-2.

In case that the controller 130 determines that the actual rotation angle of the steering wheel 10 is included in the third-second range X3-CCW instead of the second-first range X2-CW, the controller 130 may determine a value, which is made by subtracting width values (2L′) of the first reference angle section X1 and the second reference angle sections X2-CW and X2-CCW from the rotation angle of the steering wheel 10 determined in response to the output signal from the angle sensor 110, as the actual rotation angle of the steering wheel 10.

In case that the controller 130 determines that the actual rotation angle of the steering wheel 10 is included in the third-first range X3-CW instead of the second-second range X2-CCW, the controller 130 may determine a value, which is made by adding up the width values (2L′) of the first reference angle section X1 and the second reference angle sections X2-CW and X2-CCW and the rotation angle of the steering wheel 10 determined in response to the output signal from the angle sensor 110, as the actual rotation angle of the steering wheel 10.

With reference to FIG. 3, in case that the controller 130 determines that the rotation angle of the steering wheel 10 determined in response to the output signal from the angle sensor 110 is N1° and the actual rotation angle of the steering wheel 10 is included in the third-second range X3-CCW instead of the second-first range X2-CW, the controller 130 may determine a value, which is made by subtracting the width values of 2L° of the first reference angle section X1 and the second reference angle sections X2-CW and X2-CCW from N1°, as the actual rotation angle of the steering wheel 10.

In case that the controller 130 determines that the rotation angle of the steering wheel 10 determined in response to the output signal from the angle sensor 110 is −N1° and the actual rotation angle of the steering wheel 10 is included in the third-first range X3-CW instead of the second-second range X2-CCW, the controller 130 may determine a value, which is made by adding up N1° and the width values of 2L° of the first reference angle section X1 and the second reference angle sections X2-CW and X2-CCW, as the actual rotation angle of the steering wheel 10.

For example, in case that the controller 130 determines that the rotation angle section of the steering wheel 10, which may be measured in response to the output signal from the angle sensor 110, is −740° to +740° and the rotation angle of the steering wheel 10 determined in response to the output signal from the angle sensor 110 is 680° included in the second-first range X2-CW or the actual rotation angle is included in the third-second range X3-CCW, the controller 130 may determine that the actual rotation angle of the steering wheel 10 is −800° by the computation of 680° to 1480°.

In addition, in case that the controller 130 determines that the rotation angle section of the steering wheel 10, which may be measured in response to the output signal from the angle sensor 110, is −740° to +740° and the rotation angle of the steering wheel 10 determined in response to the output signal from the angle sensor 110 is −680° included in the second-second range X2-CCW or the actual rotation angle is included in the third-first range X3-CW, the controller 130 may determine that the actual rotation angle of the steering wheel 10 is 800° by the computation of 1480°+(−680°).

The controller 130 may control the steering motor 40 on the basis of the steering angle of the steering wheel 10.

For example, the controller 130 may control the steering motor 40 so that the rack bar assembly 30 moves to a target position on the basis of the determined rotation angles of the steering wheel 10 and/or the steering column 20.

With reference to FIG. 2, the controller 130 may include a memory 131 and/or a processor 133.

The memory 131 may store or memorize programs (and/or algorithms) and data for implementing an operation of controlling the angle sensing device 100.

The memory 131 may store information on a maximum rotation range corresponding to a maximally rotatable range of the steering wheel 10.

The memory 131 may store information on an overall steering range and a maximum steering range of the steering wheel 10 that may be determined in response to the output signal from the angle sensor 110.

The memory 131 may store in advance information on the plurality of reference angle sections.

The memory 131 may provide the stored programs and data to the processor 133 and memorize temporary data generated during the operation of the processor 133. For example, the memory 131 may include volatile memories, such as a static random access memory (S-RAM) and a dynamic random access memory (D-RAM), and non-volatile memories, such as a read-only memory (ROM), an erasable programmable read-only memory (EPROM), and a flash memory.

The processor 133 may provide control signals for controlling the operations of the components included in the angle sensing device 100.

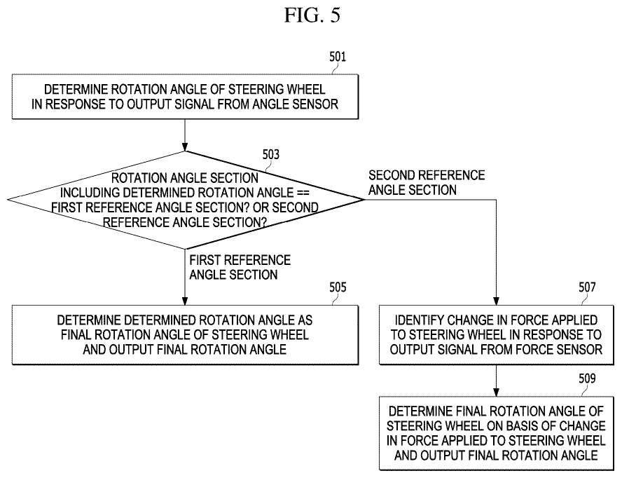

FIG. 5 is a flowchart of an operation of the angle sensing device 100 according to the embodiment (and/or the controller 130).

With reference to FIG. 5, when the vehicle is turned on, the angle sensing device 100 may determine the rotation angle of the steering wheel 10 in response to the output signal from the angle sensor 110 (501).

The angle sensing device 100 may determine whether the rotation angle section including the determined rotation angle is the first reference angle section or the second reference angle section (503).

For example, the first reference angle section may be the first reference angle section X1 in FIG. 3, i.e., the section in which the rotation angle of the steering wheel 10 determined in response to the output signal from the angle sensor 110 corresponds to the actual rotation angle.

In addition, the second reference angle section may be the section continuous from the first reference angle section, i.e., the second reference angle sections X2-CW and X2-CCW in FIG. 3, and the second reference angle section is the section in which the rotation angle of the steering wheel 10 determined in response to the output signal from the angle sensor 110 may correspond to or may not correspond to the actual rotation angle.

The angle sensing device 100 may perform operation 505 in case that the rotation angle section including the determined rotation angle is the first reference angle section, and the angle sensing device 100 may perform operation 507 in case that the rotation angle section including the determined rotation angle is the second reference angle section.

The angle sensing device 100 may determine the determined rotation angle as the final rotation angle of the steering wheel 10 and output the final rotation angle (505).

The angle sensing device 100 may identify the change in force applied to the steering wheel 10 and identified in response to the output signal from the force sensor 120 (507).

The change in force applied to the steering wheel 10 and identified in response to the output signal from the force sensor 120 may include the change in torque value of the steering wheel 10 identified in response to the output signal from the torque sensor 121 and/or the change in torque value of the steering motor 40 acquired in response to the output signal from the current sensor 123.

For example, in case that the driver manipulates the steering wheel 10 so that the steering wheel 10 rotates clockwise and/or counterclockwise, the angle sensing device 100 may identify the torque value of the steering wheel 10 in response to the output signal from the torque sensor 121. For example, the driver may manipulate the steering wheel 10 so that the steering wheel 10 sequentially rotates clockwise and then rotates counterclockwise (or rotates counterclockwise and then rotates clockwise) within a short time after the vehicle is turned on.

As another example, the angle sensing device 100 may output a control signal for operating the steering motor 40 so that the steering wheel 10 rotates clockwise and/or counterclockwise. In addition, the angle sensing device 100 may acquire the current value in response to the output signal from the current sensor 123 and acquire the torque value of the steering motor 40 on the basis of current value during the operation of the steering motor 40.

The angle sensing device 100 may output the control signal for operating the steering motor 40 in response to operation 503 described above. For example, the angle sensing device 100 may operate the steering motor 40 so that the steering wheel 10 sequentially rotates clockwise and then rotates counterclockwise (or rotates counterclockwise and then rotates clockwise) in case that the determined rotation angle is included in the second-first range X2-CW. In addition, the angle sensing device 100 may operate the steering motor 40 so that the steering wheel 10 sequentially rotates clockwise and then rotates counterclockwise (or rotates counterclockwise and then rotates clockwise) in case that the determined rotation angle is included in the second-second range X2-CCW.

The angle sensing device 100 may determine the final rotation angle of the steering wheel 10 on the basis of the change in force applied to the steering wheel 10 and output the final rotation angle (509).

For example, the angle sensing device 100 may determine the final rotation angle of the steering wheel 10 on the basis of the torque value of the steering wheel 10 acquired in response to the output signal from the torque sensor 121.

The angle sensing device 100 may determine the final rotation angle of the steering wheel 10 in case that the determined rotation angle is included in the second-first range W2-CW and the value of the amount of change between the minimum value and the maximum value of the torque value of the torque sensor 121 with respect to the displacement of the rotation angle of the steering wheel 10 in the clockwise direction is increased by the manipulation of the driver. In contrast, the angle sensing device 100 may determine a value, which is made by subtracting a maximum rotation range value (2L′) of the angle sensor 110 from the determined rotation angle, as the final rotation angle of the steering wheel 10 in case that the determined rotation angle is included in the second-first range W2-CW and the value of the amount of change between the minimum value and the maximum value of the torque value of the torque sensor 121 with respect to the displacement of the rotation angle of the steering wheel 10 in the clockwise direction is decreased by the manipulation of the driver.

In addition, the angle sensing device 100 may determine the final rotation angle of the steering wheel 10 in case that the determined rotation angle is included in the second-second range X2-CCW and the value of the amount of change between the minimum value and the maximum value of the torque value of the torque sensor 121 with respect to the displacement of the rotation angle of the steering wheel 10 in the clockwise direction is decreased by the manipulation of the driver. In contrast, the angle sensing device 100 may determine a value, which is made by adding up the determined rotation angle and the maximum rotation range value (2L′) of the angle sensor 110, as the final rotation angle of the steering wheel 10 in case that the determined rotation angle is included in the second-second range X2-CCW and the value of the amount of change between the minimum value and the maximum value of the torque value of the torque sensor 121 with respect to the displacement of the rotation angle of the steering wheel 10 in the clockwise direction is increased by the manipulation of the driver.

As another example, the angle sensing device 100 may determine the torque value of the steering motor 40 on the basis of the current value acquired in response to the output signal from the current sensor 123 and determine the final rotation angle of the steering wheel 10 on the basis of the torque value of the steering motor 40 during the operation of the steering motor 40.

The angle sensing device 100 may determine the final rotation angle of the steering wheel 10 in case that the determined rotation angle is included in the second-first range W2-CW and the value of the amount of change between the minimum value and the maximum value of the torque value of the steering motor 40 with respect to the displacement of the rotation angle of the steering wheel 10 in the clockwise direction is increased. In contrast, the angle sensing device 100 may determine the value, which is made by subtracting the maximum rotation range value (2L°) of the angle sensor 110 from the determined rotation angle, as the final rotation angle of the steering wheel 10 in case that the determined rotation angle is included in the second-first range W2-CW and the value of the amount of change between the minimum value and the maximum value of the torque value of the steering motor 40 with respect to the displacement of the rotation angle of the steering wheel 10 in the clockwise direction is decreased.

In addition, the angle sensing device 100 may determine the final rotation angle of the steering wheel 10 in case that the determined rotation angle is included in the second-second range X2-CCW and the value of the amount of change between the minimum value and the maximum value of the torque value of the steering motor 40 with respect to the displacement of the rotation angle of the steering wheel 10 in the clockwise direction is decreased. In contrast, the angle sensing device 100 may determine the value, which is made by adding up the determined rotation angle and the maximum rotation range value (2L′) of the angle sensor 110, as the final rotation angle of the steering wheel 10 in case that the determined rotation angle is included in the second-second range X2-CCW and the value of the amount of change between the minimum value and the maximum value of the torque value of the steering motor 40 with respect to the displacement of the rotation angle of the steering wheel 10 in the clockwise direction is increased.

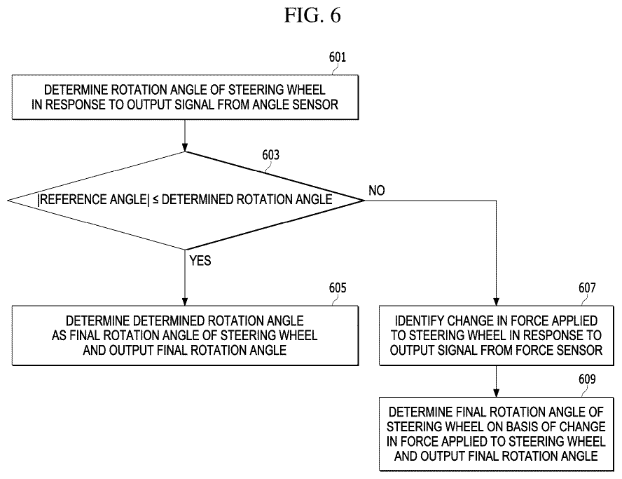

FIG. 6 is a flowchart of an operation of the angle sensing device 100 according to the embodiment (and/or the controller 130).

With reference to FIG. 6, when the vehicle is turned on, the angle sensing device 100 may determine the rotation angle of the steering wheel 10 in response to the output signal from the angle sensor 110 (601).

The angle sensing device 100 may identify whether the determined rotation angle is |reference angle| or more (603).

For example, |reference angle| may be K° in FIG. 3. Therefore, the angle sensing device 100 may identify whether the determined rotation angle is the second reference angle (−K°) or more and the first reference angle (+K°) or less.

The angle sensing device 100 may perform operation 605 in case that the determined rotation angle is |reference angle| or more. Otherwise, the angle sensing device 100 may perform operation 607.

The angle sensing device 1 may determine the determined rotation angle as the final rotation angle of the steering wheel 10 and output the final rotation angle (605).

The angle sensing device 100 may identify the change in force applied to the steering wheel 10 and identified in response to the output signal from the force sensor 120 (607).

The angle sensing device 100 may identify the change in force applied to the steering wheel 10 and identified in response to the output signal from the force sensor 120 by outputting the control signal for the manipulation of the steering wheel 10 by the driver and/or the operation of the steering motor 40 of the angle sensing device 100 so that the steering wheel 10 rotates clockwise and/or counterclockwise.

The angle sensing device 100 may determine the final rotation angle of the steering wheel 10 on the basis of the change in force applied to the steering wheel 10 and output the final rotation angle (609).

Because the embodiment in the final rotation angle of the steering wheel 10 is determined on the basis of the change in force applied to the steering wheel 10 has been described above, a description of the detailed operations will be omitted.

The angle sensing device and the method of controlling the same according to the above-mentioned embodiments may provide a new technology capable of detecting the rotation range of the steering wheel larger than the maximum rotation range of the steering wheel that may be determined on the basis of the output value from the angle sensor.

Meanwhile, the disclosed embodiments may be implemented in the form of a recording medium that stores instructions executable by a computer. The instructions may be stored in the form of program codes, and when executed by a processor, the instructions may perform operations of the disclosed embodiments by generating a program module. The recording medium may be implemented as a computer-readable recording medium.

The computer-readable recording medium may include all kinds of recording media storing instructions that can be interpreted by a computer. For example, the computer-readable recording medium may be Read Only Memory (ROM), Random Access Memory (RAM), a magnetic tape, a magnetic disc, flash memory, an optical data storage device, etc.

A machine-readable storage medium may be provided in the form of a non-transitory storage medium, wherein the term ‘non-transitory’: simply means that the storage medium is a tangible device, and does not include a signal (e.g., an electromagnetic wave), but this term does not differentiate between where data is semi-permanently stored in the storage medium and where the data is temporarily stored in the storage medium.

So far, the disclosed embodiments have been described with reference to the accompanying drawings. It will be understood by one of ordinary skill in the technical art to which the disclosure belongs that the disclosure can be embodied in different forms from the disclosed embodiments without changing the technical spirit and essential features of the disclosure. Thus, it should be understood that the disclosed embodiments described above are merely for illustrative purposes and not for limitation purposes in all aspects.

What is claimed is:

1. An angle sensing device, comprising:
one or more angle sensors configured to output an output signal corresponding to a rotation of a steering wheel of a vehicle;
a force sensor configured to output information corresponding to a force applied to the steering wheel; and
a controller connected to the one or more angle sensors and the force sensor,
wherein the controller is configured to:
determine a rotation angle of the steering wheel based on the output signal from the one or more angle sensors;
in response to the determined rotation angle being included in a first reference angle section among a plurality of reference angle sections,
determine the determined rotation angle as a final rotation angle of the steering wheel; and
in response to the determined rotation angle being included in a second reference angle section continuous from the first reference angle section among the plurality of reference angle sections,
determine the final rotation angle based on a change in the force applied to the steering wheel and identified through the information from the force sensor during an operation of a steering motor of the vehicle.

2. The angle sensing device of claim 1, wherein the controller is configured to operate the steering motor so that the steering wheel rotates in at least one of a clockwise direction or a counterclockwise direction.

3. The angle sensing device of claim 2, wherein the second reference angle section comprises:
a first range to a value increased by a preset value from a maximum value of the first reference angle section; and
a second range to a value decreased by the preset value from a minimum value of the first reference angle section.

4. The angle sensing device of claim 3, wherein the controller is configured to determine the determined rotation angle as the final rotation angle in response to
the determined rotation angle being included in the first range, and
a magnitude of the force applied to the steering wheel being increased when the steering motor performs a first operation so that the steering wheel rotates clockwise.

5. The angle sensing device of claim 4, wherein the controller is configured to determine a value, which is obtained by subtracting a maximum rotation range value of the one or more angle sensors from the determined rotation angle, as the final rotation angle in response to
the determined rotation angle being included in the first range, and
the magnitude of the force applied to the steering wheel being decreased when the steering motor performs the first operation.

6. The angle sensing device of claim 3, wherein the controller is configured to determine the determined rotation angle as the final rotation angle in response to
the determined rotation angle being included in the second range, and
a magnitude of the force applied to the steering wheel being decreased when the steering motor performs a second operation so that the steering wheel rotates counterclockwise.

7. The angle sensing device of claim 6, wherein the controller is configured to determine a value, which is obtained by adding up the determined rotation angle and a maximum rotation range value of the one or more angle sensors, as the final rotation angle in response to
the determined rotation angle being included in the second range, and
the magnitude of the force applied to the steering wheel being increased when the steering motor performs the second operation.

8. The angle sensing device of claim 3, wherein the force sensor comprises:
at least one of a torque sensor configured to acquire a torque value applied to the steering wheel, or a current sensor configured to acquire a current value supplied to the steering motor.

9. The angle sensing device of claim 8, wherein the controller is configured to operate the steering motor so that the steering wheel sequentially rotates clockwise and then rotates counterclockwise, or the steering wheel sequentially rotates counterclockwise and then rotates clockwise, in response to the determined rotation angle being included in the first range or the second range.

10. The angle sensing device of claim 9, wherein the controller is configured to:
in response to the determined rotation angle being included in the first range, identify a first amount of change between a minimum value and a maximum value of
the torque value acquired by the torque sensor in accordance with a clockwise rotation of the steering wheel, or
a torque value obtained from the current value acquired by the current sensor in an operation of the steering motor that sequentially rotates the steering wheel; and
determine the determined rotation angle as the final rotation angle in response to a value of the first amount of change being increased.

11. The angle sensing device of claim 10, wherein the controller is configured to determine a value, which is obtained by subtracting a maximum rotation range value of the one or more angle sensors from the determined rotation angle, as the final rotation angle, in response to the value of the first amount of change being decreased.

12. The angle sensing device of claim 9, wherein the controller is configured to:
in response to the determined rotation angle being included in the second range, identify a second amount of change between a minimum value and a maximum value of
the torque value acquired by the torque sensor in accordance with the clockwise rotation of the steering wheel, or
a torque value obtained from the current value acquired by the current sensor in an operation of the steering motor that sequentially rotates the steering wheel; and
determine the determined rotation angle as the final rotation angle in response to a value of the second amount of change being decreased.

13. The angle sensing device of claim 12, wherein the controller is configured to determine a value, which is obtained by adding up the determined rotation angle and a maximum rotation range value of the one or more angle sensors, as the final rotation angle, in response to the value of the second amount of change being increased.

14. An angle sensing device, comprising:
one or more angle sensors configured to output an output signal corresponding to a rotation of a steering wheel of a vehicle;
a force sensor configured to acquire information corresponding to a force applied to the steering wheel; and
a controller connected to the one or more angle sensors and the force sensor,
wherein the controller is configured to:
determine a rotation angle of the steering wheel based on the output signal from the one or more angle sensors;
in response to the determined rotation angle being equal to or smaller than a first reference angle and equal to or larger than a second reference angle smaller than the first reference angle,
determine the determined rotation angle as a final rotation angle of the steering wheel; and
in response to the determined rotation angle being larger than the first reference angle or smaller than the second reference angle,
determine the final rotation angle based on a change in the force applied to the steering wheel and identified based on the information from the force sensor during an operation of a steering motor of the vehicle.

15. The angle sensing device of claim 14, wherein the controller is configured to determine the determined rotation angle as the final rotation angle in response to
the determined rotation angle being larger than the first reference angle, and
a magnitude of the force applied to the steering wheel being increased when the steering motor performs a first operation so that the steering wheel rotates clockwise.

16. The angle sensing device of claim 15, wherein the controller is configured to determine a value, which is obtained by subtracting a maximum rotation range value of the one or more angle sensors from the determined rotation angle, as the final rotation angle in response to
the determined rotation angle being larger than the first reference angle, and
the magnitude of the force applied to the steering wheel being decreased when the steering motor performs the first operation.

17. The angle sensing device of claim 14, wherein the controller is configured to determine the determined rotation angle as the final rotation angle in response to
the determined rotation angle being smaller than the first reference angle, and
a torque value of the steering motor being decreased when the steering motor performs a second operation so that the steering wheel rotates counterclockwise.

18. The angle sensing device of claim 17, wherein the controller is configured to determine a value, which is obtained by adding up the determined rotation angle and a maximum rotation range value of the one or more angle sensors, as the final rotation angle in response to
the determined rotation angle being smaller than the first reference angle, and
the torque value of the steering motor being increased when the steering motor performs the second operation.

19. A method of controlling an angle sensing device, the method comprising:
determining a rotation angle of a steering wheel of a vehicle based on an output signal from one or more angle sensors, the output signal corresponding to a rotation of the steering wheel;
in response to the determined rotation angle being included in a first reference angle section among a plurality of reference angle sections,
determining the determined rotation angle as a final rotation angle of the steering wheel; and
in response to the determined rotation angle being included in a second reference angle section continuous from the first reference angle section among the plurality of reference angle sections,
determining the final rotation angle based on a change in a force applied to the steering wheel and identified through information output by a force sensor, the information corresponding to the force applied to the steering wheel during an operation of a steering motor of the vehicle.

20. The method of claim 19, wherein the operation of the steering motor comprises the steering motor causing the steering wheel to rotate in at least one of a clockwise direction or a counterclockwise direction.
